(19) United States
(12) Patent Application Publication
(10) Pub. No.: US 2009/0038422 A1
(43) Pub. Date: Feb. 12, 2009

(54) Device for adjusting angle of monitor for vehicle

(76) Inventor: In Young Choi, Jeonju-si (KR)

Correspondence Address: MORGAN, LEWIS & BOCKIUS LLP (SF), One Market, Spear Street Tower, Suite 2800, San Francisco, CA, 94105, US

(21) Appl. No.: 11/953,721

(22) Filed: Dec. 10, 2007

(30) Foreign Application Priority Data
Aug. 7, 2007 (KR) 10-2007-0079076

(51) Int. Cl. F16H 29/20

(52) U.S. Cl. 74/89.17

(57) ABSTRACT

A device for adjusting an angle of a monitor includes a guide unit fastened to a roof panel of a vehicle. The guide unit includes at least one toothed rail with a horizontal track part and an arc-shaped track part. The device also includes a rotation shaft mounted to the monitor, having gear teeth engaged with the toothed rail.

### CROSS-REFERENCE TO RELATED APPLICATIONS

This application claims priority to Korean Application No. 10-2007-0079076, filed on Aug. 7, 2007, the disclosure of which is incorporated herein by reference.

### BACKGROUND OF THE INVENTION

1. Field of the Invention

The present invention relates to a device for adjusting the angle of a monitor for a vehicle.

2. Description of the Prior Art

Long-distance traveling vehicles, such as buses, often include video monitors mounted to a roof panel and pivoted around a pivot shaft. When the monitor is not in use, it is folded to the roof panel. For use, the monitor is pivoted around the pivot shaft to an open position. The angle of the monitor cannot be adjusted.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

A device for adjusting an angle of a monitor includes a guide unit fastened to a roof panel of a vehicle. The guide unit includes at least one toothed rail with a horizontal track part and an arc-shaped track part. The device also includes a rotation shaft mounted to the monitor, having gear teeth engaged with the toothed rail.

The guide unit may also include guide rails, each with a horizontal guide groove and an arc-shaped guide groove. A guide bar may be mounted to the monitor and movable along the guide rail.

The guide bar may extend through the monitor, parallel to the rotation shaft.

The arc-shaped track part may include an angle adjustment track part, which extends beyond an end of the arc-shaped guide groove.

The guide unit may include a base, and a side cover secured to an edge of the base. The toothed rail is disposed in the side cover.

The angle adjustment track part may be an arc of a circle, with the end of the arc-shaped guide groove at the center.

### BRIEF DESCRIPTION OF THE DRAWINGS

FIG. 1 is a perspective view illustrating a device for adjusting the angle of a monitor for a vehicle in accordance with an embodiment of the present invention;

FIG. 2 is an exploded perspective view of the device of FIG. 1;

FIG. 3 is a perspective view illustrating horizontal movement of the monitor of the device of FIG. 1;

FIG. 4 is a partial enlarged perspective view illustrating an angle adjustment track part of the device of FIG. 1; and

FIG. 5 is a perspective view illustrating the tilting movement of the monitor of the device of FIG. 1.

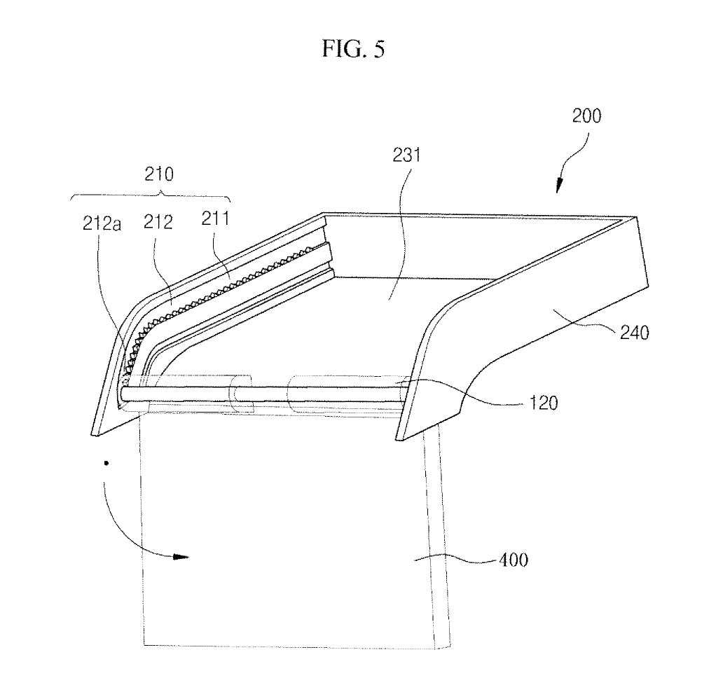

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF PREFERRED EMBODIMENTS

Reference will now be made in detail to a preferred embodiment of the present invention, an example of which is illustrated in the accompanying drawings and described below. While the invention will be described in conjunction with an exemplary embodiment, it should be understood that the description is not intended to limit the invention to the exemplary embodiment. On the contrary, the invention is intended to cover not only the exemplary embodiment, but also various alternatives, modifications, equivalents and other embodiments, which may be included within the spirit and scope of the invention as defined by the appended claims.

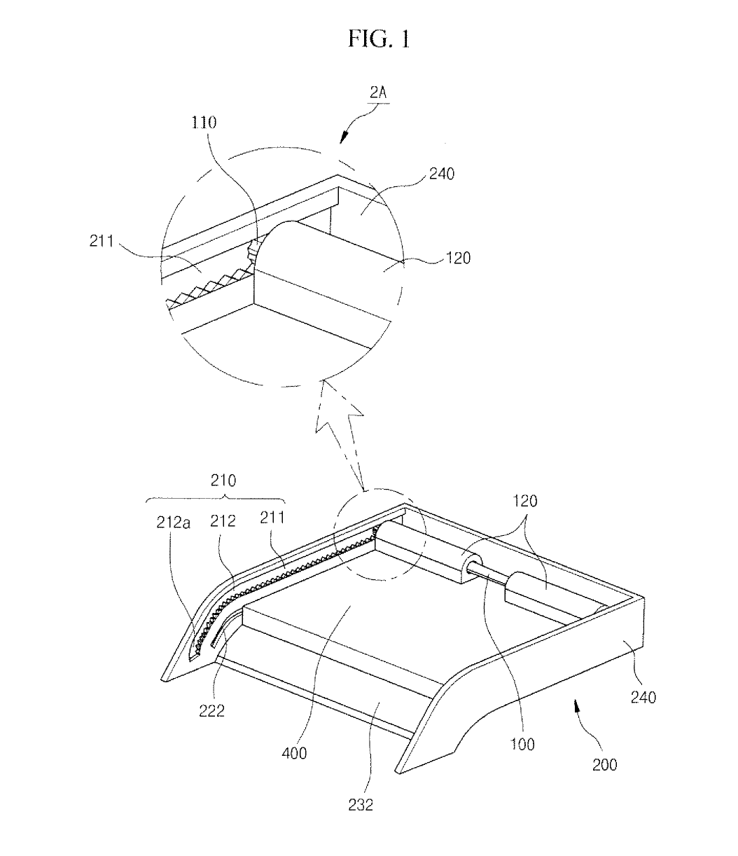

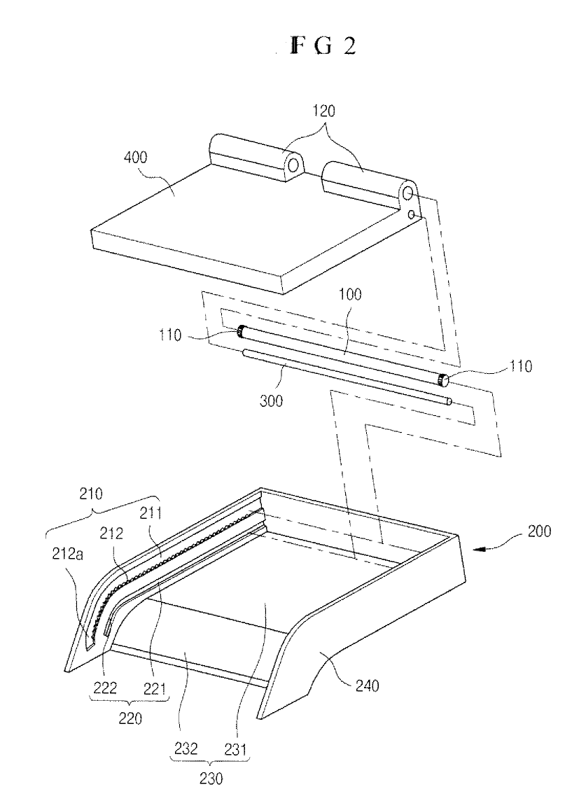

Referring, to FIGS. 1 through 3, a device for adjusting the angle of a monitor 400 mounted to a roof panel of a vehicle is provided. The device includes a rotation shaft 100 which has gears 110 at both ends and is rotatably installed on the monitor 400, and a guide unit 200 which has toothed rails 210 engaged with the gear teeth 110 so as to permit horizontal movement and tilting movement of the monitor 400 upon rotation of the rotation shaft 100.

A driving part 120 for rotatably driving the rotation shaft 100 is provided on the monitor 400. A motor (not shown) is disposed in the driving part 120 to rotate the rotation shaft 100.

It is contemplated that the gear 110 could be provided on only one end of the rotation shaft 100, or at any appropriate position.

A guide member such as a guide bar 300 extends through the monitor 400 parallel to the rotation shaft 100. When the monitor 400 is moved, the guide bar 300 moves along guide rails 220 of the guide unit 200, which will be described in detail below, to guide the movement of the monitor 400 and prevent vibration of the monitor 400.

The guide unit 200 includes a base 230 having a flat horizontal movement part 231 and an arc-shaped tilting movement part 232 which is connected to the horizontal movement part 231, and a side cover 240 secured to the edges of the horizontal movement part 231 and the tilting movement part 232. The edge of the tilting movement part 232 that faces away from the horizontal movement part 231, i.e. the bottom left in the Figures, is open. The side cover 240 has therein the toothed rails 210 and the guide rails 220.

Each toothed rail 210 has a horizontal track part 211 which extends in the side cover 240 in a horizontal direction to permit the horizontal movement of the gear 110, and an arc-shaped track part 212 which extends from the end of the horizontal track part 211 in the shape of an arc to permit the tilting movement of the gear 110.

Each guide rail 220 has a horizontal guide groove 221 which extends horizontally in the side cover 240, and an arc-shaped guide groove 222 which extends from the end of the horizontal guide groove 221 in the shape of an arc.

Therefore, when the gear 110 are moved horizontally along the horizontal track parts 211, the guide bar 300 is moved horizontally along the horizontal guide grooves 221 to guide the horizontal movement of the monitor 400. Also, when the gears 110 are moved along the arc-shaped track parts 212, the guide bar 300 is moved along the arc-shaped guide grooves 222 to guide the tilting movement of the monitor 400. As a result, smooth horizontal movement and tilting movement of the monitor 400 is ensured.

The arc-shaped track part 212 has an angle adjustment track part 212a for adjusting the angle of the monitor 400.

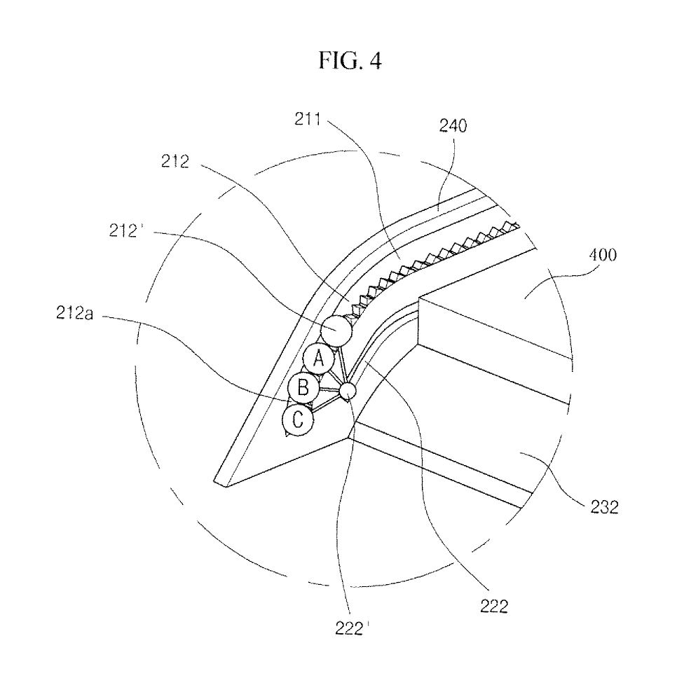

When the gear 110 is moved along arc-shaped track part 212 and the guide bar 300 is moved along the arc-shaped guide groove 222, the gear 110 and the guide bar 300 move to the end 212′ of the arc-shaped track part 212 and to the end 222′ of the arc-shaped guide groove 222. Then, the gear 110 can be moved along the angle adjustment track part 212a while tracing a circular path, and the guide bar 300 pivots at the end 222′ of the arc-shaped guide groove 222. A user can thus control the position of the gear 110 on the angle adjustment track part 212a, for example, at position A, B, or C of FIG. 4, adjusting the angle of the monitor 400.

Operation of the device will now be described.

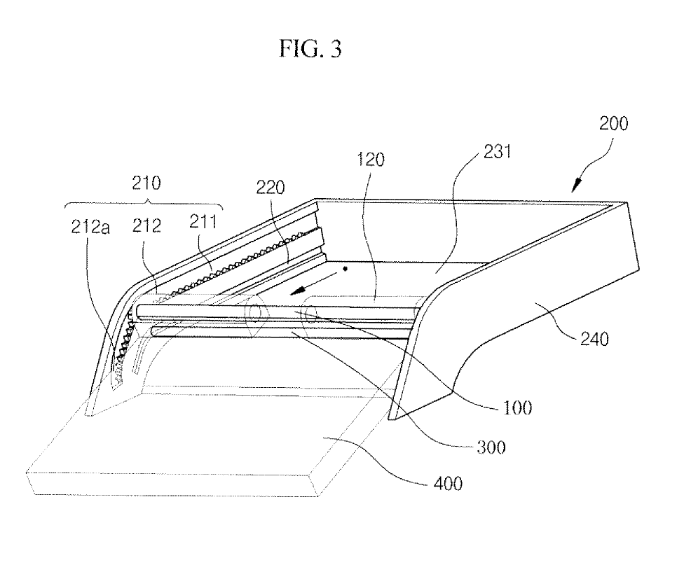

If the rotation shaft 100 is rotated by the driving part 120, as shown in FIG. 3, the gears 110 of the rotation shaft 100 are horizontally moved along the horizontal track parts 211, and the guide bar 300 is horizontally moved along the horizontal guide grooves 221. Thereby, the monitor 400 is horizontally moved.

As the gears 110 and the guide bar 300 are introduced into the arc-shaped track parts 212 and the arc-shaped guide grooves 222, respectively, as shown in FIG. 4, the monitor 400 tilts.

Thereafter, as the gears 110 and the guide bar 300 respectively reach the ends 212′ of the arc-shaped track parts 212 and the ends 222′ of the arc-shaped guide grooves 222, the gears 110 are moved along the angle adjustment track parts 212a while tracing a circular path, and the guide bar 300 is pivoted at the positions of the ends 222′ of the arc-shaped guide grooves 222, adjusting the angle of the monitor 400.

Although a preferred embodiment of the present invention has been described for illustrative purposes, those skilled in the art will appreciate that various modifications, additions and substitutions are possible, without departing from the scope and spirit of the invention as defined in the accompanying claims.

What is claimed is:

1. A device for adjusting an angle of a monitor, comprising:
a guide unit configured to be fastened to a roof panel of a vehicle, comprising at least one toothed rail, the rail comprising a horizontal track part and an arc-shaped track part; and
a rotation shaft mounted to the monitor and comprising gear teeth engaged with the toothed rail.

2. The device according to claim 1, wherein the guide unit further comprises at least one guide rail comprising a horizontal guide groove and an arc-shaped guide groove, and the device further comprises a guide member mounted to the monitor and movable along the guide rail.

3. The device according to claim 2, wherein the guide member comprises a guide bar which extends through the monitor and is substantially parallel to the rotation shaft.

4. The device according to claim 2, wherein the arc-shaped track part comprises an angle adjustment track part, which extends beyond an end of the arc-shaped guide groove.

5. The device according to claim 1, wherein the guide unit comprises a base, and a side cover secured to an edge of the base, wherein the toothed nail is disposed in the side cover.

6. The device according to claim 4, wherein the angle adjustment track part comprises an arc of a circle, wherein the end of the arc-shaped guide groove is disposed at a center of the circle.
